(19) United States
(12) Patent Application Publication
(10) Pub. No.: US 2011/0084611 A1
(43) Pub. Date: Apr. 14, 2011

(54) MITIGATING SPARKS IN AN ION WIND FAN

(75) Inventors: Daniel Jon SCHLITZ, Northbrook, IL (US); Anil Khubchandani, San Jose, CA (US)

(73) Assignee: Ventiva, Inc., Santa Clara, CA (US)

(21) Appl. No.: 12/576,791

(22) Filed: Oct. 9, 2009

(51) Int. Cl. H01J 7/24

(52) U.S. Cl. 315/111.81

(57) ABSTRACT

Ion wind fans are susceptible to sparks occurring across an emitter electrode and a collector electrode of an ion wind fan. According to one embodiment, the present invention includes mitigating a spark event by providing a resistor in series between an ion wind fan power supply and an ion wind fan. In one embodiment, the resistance of the resistor is at least one order of magnitude lower than the resistance across the ion wind fan during normal operation.

### FIELD OF THE INVENTION

The present invention is related to ion wind fans, and more particularly to methods and apparatuses related to managing sparks in an ion wind fan.

### BACKGROUND

It is well known that heat can be a problem in many electronics device environments, and that overheating can lead to failure of components such as integrated circuits (e.g. a central processing unit (CPU) of a computer) and other electronic components. Heat sinks are a common device used to prevent overheating. Heat sinks rely mainly on the dissipation of heat from the device using air. To increase the heat dissipation of a heat sink, a conventional rotary fan has been used to move air across the surface of the heat sink. Conventional fans have many disadvantages when used in consumer electronics products, such as noise, weight, size, and failure of moving parts and bearings. A solid-state fan using ion wind, also known as corona wind, to move air addresses the disadvantages of conventional fans. However, providing an ion wind fan that meets the requirements of consumer electronics devices presents numerous challenges not addressed by any currently existing ionic wind device.

One problem of currently existing ion wind devices is sparking across electrodes. Sparks can damage electrodes and other electronic components, create a sharp easily audible noise, and can create electromagnetic interference (EMI).

### BRIEF DESCRIPTION OF THE DRAWINGS

FIG. 1 is a block diagram illustrating an ion wind fan implemented as part of thermal management of an electronic device;

FIG. 2A is a block diagram illustrating an ion wind fan power supply having a spark mitigation resistor according to one embodiment of the present invention;

FIG. 2B is a block diagram illustrating an system having an ion wind fan and including a spark mitigation resistor according to another embodiment of the present invention;

FIG. 2C is a block diagram illustrating an ion wind fan having a spark mitigation resistor according to yet another embodiment of the present invention;

FIG. 3 is a block diagram illustrating an ion wind fan having multiple spark mitigation resistors according to one embodiment of the present invention;

FIG. 4 is a block diagram illustrating an ion wind fan having a spark mitigation resistor according to an embodiment of the present invention that uses alternating current for the ion wind fan;

FIG. 5 is a flow diagram illustrating a process for building a thermal management system incorporating according to one embodiment of the present invention; and

FIG. 6 is a block diagram illustrating an ion wind fan power supply having a spark mitigation resistor as part of a resistor bypass circuit according to one embodiment of the present invention.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Ion wind or corona wind generally refers to the gas flow that is established between two electrodes, one sharp and the other blunt, when a high voltage is applied between the electrodes. The air is partially ionized in the region of high electric field near the sharp electrode. The ions that are attracted to the more distant blunt electrode collide with neutral (uncharged) molecules en route to the collector electrode and create a pumping action resulting in air movement. The high voltage sharp electrode is generally referred to as the emitter electrode or corona electrode, and the grounded blunt electrode is generally referred to as the counter electrode or collector electrode.

The general concept of ion wind—also sometimes referred to as ionic wind and corona wind even though these concepts are not entirely synonymous—has been known for some time. For example, U.S. Pat. No. 4,210,847 to Shannon, et al., dated Jul. 1, 1980, titled “Electric Wind Generator” describes a corona wind device using a needle as the sharp corona electrode and a mesh screen as the blunt collector electrode. The concept of ion wind has been implemented in relatively large-scale air filtration devices, such as the Sharper Image Ionic Breeze.

### Example Ion Wind Fan Thermal Management Solution

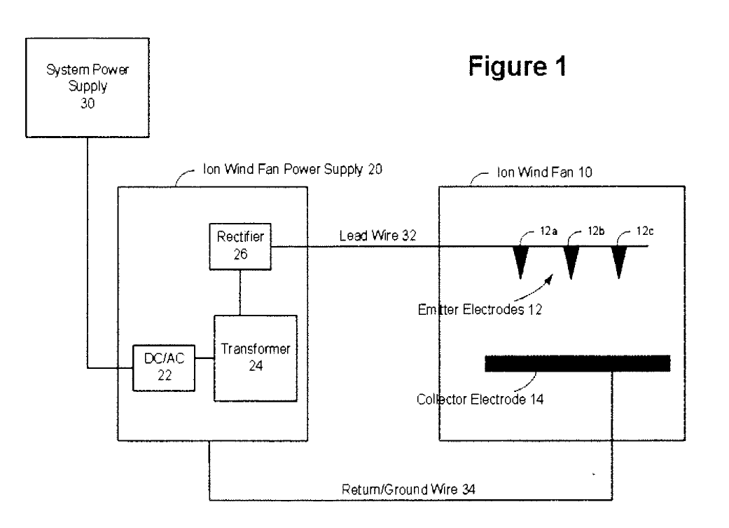

FIG. 1 illustrates an ion wind fan 10 used as part of a thermal management solution for an electronic device. The electronic device may need thermal management for an integrated circuit—such as a chip or a processor—that produces heat, or some other heat source, such as a light emitting diode. Some example systems that can use an ion wind thermal management solution include computers, laptops, gaming devices, projectors, television sets, set-top boxes, servers, NAS devices, memory devices, LED lighting devices, LED display devices, smart-phones, music players and other portable devices, and generally any device having a heat source requiring thermal management.

The electronic device system will have a system power supply 30. For example, in the case of a laptop computer, the laptop will have a system power supply such as a battery that provides electric power to the electronic components of the laptop. In the case of a wall-plug device such as a gaming device or television set, the system power supply 30 will convert the 110V AC (in the U.S.A) current from an electrical outlet into the appropriate voltage and type of current. For example, system power supply 30 of a projector would likely convert power from the outlet into approximately 3 kV-5 kV DC or equivalent AC.

The electronic device also includes a heat source (not shown), and can also include a passive thermal management element, such as a heatsink (also not shown). To assist in heat transfer, an ion wind fan 10 is provided in the system to help move air across the surface of the heat source or the heatsink. In prior art systems, conventional rotary fans with rotating fan blades have been used for this purpose.

As discussed above, the ion wind fan 10 operates by creating a high electric field around one or more emitter electrodes 12 resulting in the generation of ions, which are then attracted to a collector electrode 14. In FIG. 1, the emitter electrodes 12 are represented as triangles as an illustration that they are generally “sharp” electrodes. However, in a real-world ion wind fan 10, the emitter electrodes 12 can be implemented as wires, shims, blades, pins, and numerous other geometries. Furthermore, while there are three emitter electrodes (12a, 12b, 12c) are shown in FIG. 1, embodiments of the present invention can be implemented with any number of emitter electrodes 12.

Similarly, the collector electrode 14 is shown simply as a plate in FIG. 1. However, a real-world collector electrode 14 can have various shapes and will most likely include openings to allow the passage of air. The collector electrode 14 can also be implemented as multiple collector electrodes held at substantially the same potential. Since the specific emitter 12 and collector 14 geometries are not germane to the present invention, they are illustrated as triangles and plates for simplicity and ease of understanding. Furthermore, in a real world ion wind fan 10, the emitter electrodes 12 and the collector electrode 14 would be disposed on a dielectric chassis—sometimes referred to as an isolator element—that has also been omitted from FIG. 1 for simplicity and ease of understanding.

To create the high electric field necessary for ion generation, the ion wind fan 10 is connected to an ion wind power supply 20. The ion wind power supply 20 is a high-voltage power supply that can apply a high voltage potential across the emitter electrodes 12 and the collector electrode 14. The ion wind fan power supply 20 (hereinafter sometimes referred to as “IWFPS”) is electrically coupled to and receives electrical power from the system power supply 30. Usually for electronic devices, the system power supply 30 provides low-voltage direct current (DC) power. For example, a laptop computer system power supply would likely output approximately 5-12V DC, while the power supply for an LED light fixture would likely output approximately 50-200V DC.

To provide the high voltage necessary to drive the ion wind fan 10, in one embodiment, the IWFPS 20 converts the received low-voltage DC power to AC using a DC/AC converter 22, and uses a transformer 24 to step up the resulting AC voltage to a desired high voltage. While the specific high voltage used to drive the ion wind fan 10 will be implementation specific, generally the desired voltage will be in the 1-6 kV range. However, for larger fan implementations the operating voltage may be as high as 30 kV.

The stepped-up voltage is then provided to a rectifier 26 to convert to a high-voltage DC potential.

The high voltage DC is then electrically coupled to the emitter electrodes 12 of the ion wind fan 32 via a lead wire. The collector electrode 14 is connected back to the IWFPS 20 via return/ground wire 34, to ground the collector electrode 14 thereby creating a high voltage potential across the emitters 12 and the collector 14 electrodes. The return wire 34 can be connected to a system, local, or absolute high-voltage ground using conventional techniques.

While the system shown in and described with reference to FIG. 1 uses a positive DC voltage to generate ions, ion wind can be created using AC voltage, or by connecting the emitters 12 to the negative terminal of the IWFPS 20 resulting in a “negative” corona wind. Embodiments of the present invention are not limited to positive DC voltage ion wind. Furthermore, while the IWFPS 20 is shown to receive power from a system power supply 30, in other embodiment, the IWFPS 20 can receive power directly from an outlet.

### Sparking or Arcing in an Ion Wind Fan

As described partially above, by applying a high voltage potential across the emitter 12 and collector 14 electrodes, ion wind can be generated by the ion wind fan 10. Below some onset voltage that is specific to the electrode geometry and dependent on the air gap between the emitter electrodes 12 and the collector electrode 14 no ions are generated and ion wind is not created. Furthermore, above some threshold voltage that exceeds the dielectric breakdown voltage of the gas gap separating an emitter electrode 12 from the collector 14, a spark—i.e. short circuit—is created between the emitter electrode 12 and the collector electrode 14.

Thus, the operating voltage range of an ion wind fan 10 is dependent, inter alia, on the air gap between the emitter electrodes 12 and the collector electrode 14. While prior art air filtration systems using ion wind have been relatively large scale, an ion wind fan 10 designed as part of a thermal management solution of an electronic device will generally be very small. Such ion wind fans are in the approximate range of 20×3×2 mm up to 100×22×12 mm in size, although the present invention is not limited to ion wind fans in any particular size range.

Thus, the operating range of the of the ion wind fan 10 will be relatively narrow. For example, one tested ion wind fan has an operating range approximately 3.5-5.5 kV. At such narrow tolerances, changes in the air gap—such as a temporary increase of dust in the air—as well as changes in the electrodes over time, can result in sparking.

Sparks have several undesirable side effects. Since the electrodes of the ion wind fan 10 can be small and fragile, sparks can damage the electrodes over time. Sparks are also accompanied by an audible noise, a miniature version of thunder that accompanies lightning. Such noise is undesirable in consumer electronics devices and other devices utilizing thermal management. Also, sparks create electromagnetic interference (EMI) that can interfere with the functioning of nearby electronic component, such as the other electronic circuitry of a consumer electronics device.

### Spark Mitigation Solutions

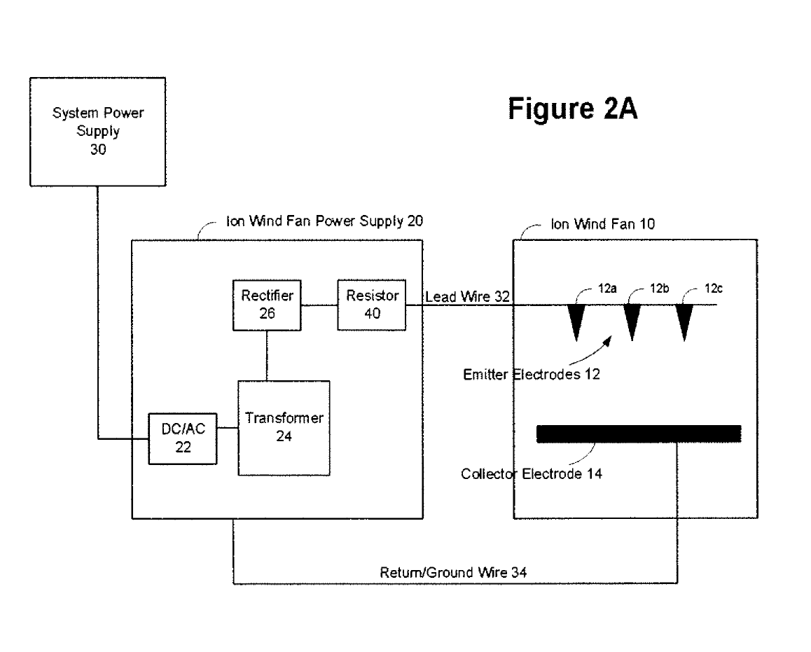

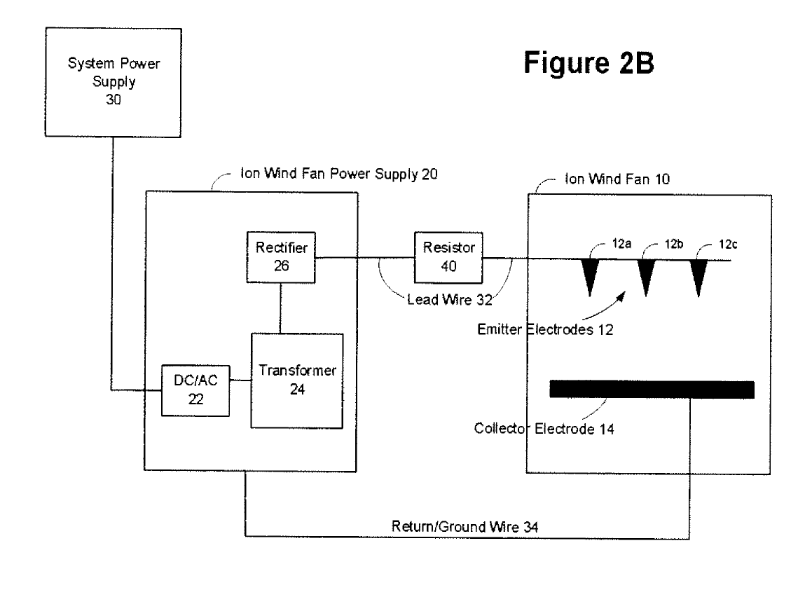

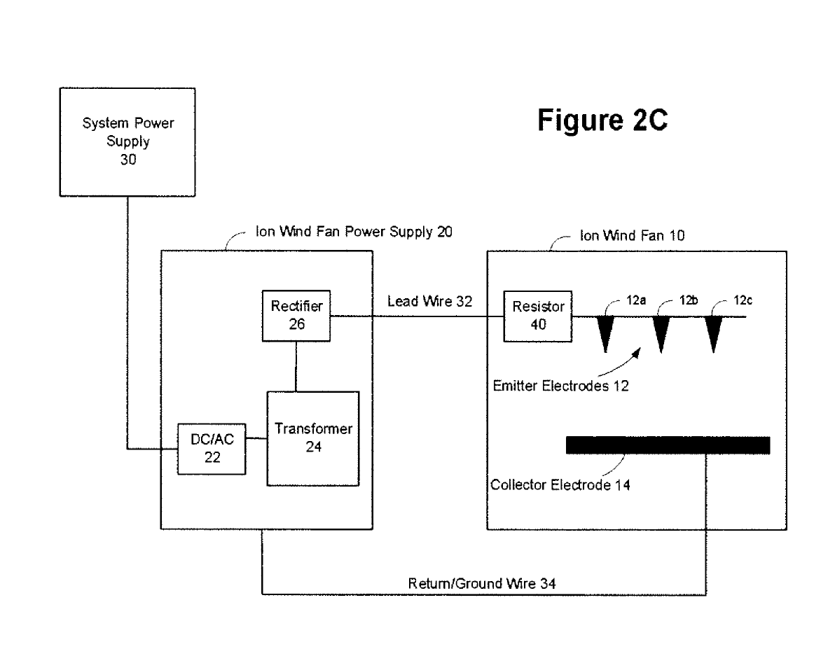

One embodiment of a spark mitigation solution is now described with reference to FIG. 2A. Most of the components and elements shown in FIG. 2A are substantially or exactly the same as those described with reference to FIG. 1, and therefore will not be described again. However, in FIG. 2A, a resistor 40 has been added to the IWFPS 20. The resistor 40, which may be sometimes referred to as a “spark mitigation resistor,” functions to mitigate the undesired side effects of sparks that were explained above. A “resistor” is any electronic component that resists the flow of current in an electronic circuit. While there are many commercially available resistors of various well-know types—such as film, carbon, wire, or integrated circuit element—as used herein, the term resistor applies to any electronic component that resists the flow of current in an electronic circuit, and is not limited to any specific resistor implementation.

When a spark occurs between one of the emitter electrodes 12 and the collector electrode 14, the current (I) in the circuit connected to the IWFPS 20 rises dramatically. When this happens, the resistor 40 functions to resist this increased current, thereby dissipating much of the energy of the spark. One challenge to implementing a resistor-based spark mitigation solution is that the resistor 40 also resists current during normal operation of the fan, and as such creates inefficiency and wastes power. The specific resistance of the resistor 40 is thus important, since if the resistance is too high, it will require significantly more power from the IWFPS 20 to operate the ion wind fan 10, and if it is too low, it will not sufficiently resist the spark current to mitigate the undesirable side effects of the spark.

By performing experiments, it was determined that the resistance across one embodiment of the ion wind fan 10 during normal operation is approximately in the range of 4-8 MΩ (megaohms). This value generally represents the cumulative resistance of the connectors, emitter wires, air gap, other electrical connections in the ion wind fan 10, although the air gap between the emitter electrodes 12 and the collector electrode 14 does provide most—over 95%—of the resistance of the ion wind fan 10. “Normal operation” of the ion wind fan 10 in this context means anytime that the fan is on and generating ions creating ion wind, except during a spark event resulting in an arc between at least one of the emitter electrodes 12 and the collector electrode 14.

The resistance across the fan during normal ion wind fan operation is dependent on several factors, such as electrode geometry, the size of the gas gap, the voltage powering the fan, and other factors. Some factors, such as voltage can vary over time. Therefore, most ion wind fans 10 will have a range of normal operation resistance as opposed to a singular value. For example, some ion wind fans have been measured having a normal operation resistance of 12-16 MΩ. While the present invention is not limited to any specific resistance range, it is currently expected that most ion wind fans 10 will have an average normal operation resistance not significantly lower than 1 MΩ.

The resistance across the ion wind fan 10 during a spark event has also been measured and modeled. During a spark event, the resistance across one embodiment of the ion wind fan 10 drops to approximately 5-15Ω. While the spark resistance of ion wind fans may vary and the present invention is not limited to any specific resistance or resistance range, for most ion wind fans 10, the resistance across the ion wind fan 10 during a spark event is not expected to be above 100Ω.

According to Ohm's law (V=IR), when the resistance of the ion wind fan 10 drops from the megaohm range (millions of ohms) to the single or double digit ohm range—a drop of 5-6 orders of magnitude—the current across the fan increases dramatically. The current increase in one embodiment is from approximately 1 mA (milliamperes) during normal fan operation to approximately 10 A (amperes) during the spark event, although the exact ranges depend on the particular ion wind fan 10.

As used herein, the term “order of magnitude” generally refers to a factor of ten. For example, a one digit number is one order of magnitude below a two digit number, two orders of magnitude below a three digit number, and so on. Used a slightly different way, it can be said that 500 is three orders of magnitude greater than 5.

In one embodiment, the spark mitigation resistor 40 is selected to have a resistance approximately at least two orders of magnitude lower than the resistance of the ion wind fan 10 during normal operation. In other words, the resistor 40 has a resistance that is less than 1/100^{th} of the resistance of the ion wind fan 10 during normal operation. As set forth above, the term “normal operation” in this context means anytime that the fan is on and generating ions creating ion wind, except during a spark event. Since the resistance of the ion wind fan 10 depends on applied voltage and current, among other factors, it is not constant during normal operation. However, the normal operation resistance of the ion wind fan 10 varies within a range that far exceeds the resistance of the ion wind fan 10 during a spark event.

In one embodiment, a resistance value that is at least two orders of magnitude less than the resistance of the ion wind fan 10 during normal operation is selected for the resistor 40. The resistance of the ion wind fan 10 during normal operation will sometimes be referred to as the “normal resistance” of the ion wind fan 10 herein. Because such a resistance value for the resistor 40 will only waste approximately 1% of the energy provided by the power supply 20, the resistor 40 will not have a significant impact on the performance and power consumption of the ion wind fan 10 during normal operation.

Furthermore, in one embodiment, the spark mitigation resistor 40 is selected to have a resistance approximately at least two orders of magnitude greater than the resistance of the ion wind fan 10 during a spark event. In other words, the resistor 40 has a resistance that is more than 100 times the resistance of the ion wind fan 10 during a spark event. The resistance of the ion wind fan 10 during a spark event will sometimes be referred to as the “spark resistance” of the ion wind fan 10 herein. By selecting a resistance value for the resistor 40 that is at least two orders of magnitude greater than the resistance of the ion wind fan 10 during a spark event, the resistor 40 will be able to dissipate most of the energy of the spark by reducing the current by at least a factor of 100.

As an example, if a specific ion wind fan 10 has a resistance of approximately 8 MΩ during normal operation, and a resistance of approximately 7Ω during a spark event, then the spark mitigation resistor 40 can have a resistance anywhere in the range of 700-80,000Ω. In one embodiment, it is desirable to create as little additional resistance as practicable during normal fan operation, thus resulting in the selection of the resistance value for the resistor 40 from the lower end of this range. For example, for the range above, the resistance for the resistor 40 can be approximately 1 KΩ.

Thus, in another embodiment, the resistance of the resistor 40 would be at least three orders of magnitude less than the resistance of the ion wind fan 10 during normal operation. In yet another embodiment, the selection range of the resistor can be expanded by only requiring that the resistance of the resistor 40 be at least one order of magnitude less than the resistance of the ion wind fan 10 during normal operation, and at least one orders of magnitude greater than the resistance of the ion wind fan 10 during a spark event.

In yet another embodiment, the spark mitigation role of the resistor 40 can be far more important than efficiency and power usage of the ion wind fan 10. In such an embodiment, the resistance value for the spark mitigation resistor may be as high as only 10-20% lower than the normal resistance of the ion wind fan.

In FIG. 2A, the spark mitigation resistor 40 is shown and described as being a part of the IWFPS 20. While the physical location of the IWFPS 20 is a logical and convenient place to implement the resistor 40, other implementations are also possible. For example, according to one embodiment shown in FIG. 2B, the resistor 40 is located somewhere between the IWFPS 20 and the ion wind fan 10. In fact, the resistor 40 can be implemented anywhere along the lead wire 32 connecting the power terminal (positive terminal in the case of positive coronal emitters) to the emitter electrodes 12.

Furthermore, as shown in FIG. 2C, the resistor 40 can also be located on or within the physical structure of the ion wind fan 10. In FIGS. 2A-C, the resistor 40 is in series with the ion wind fan 10.

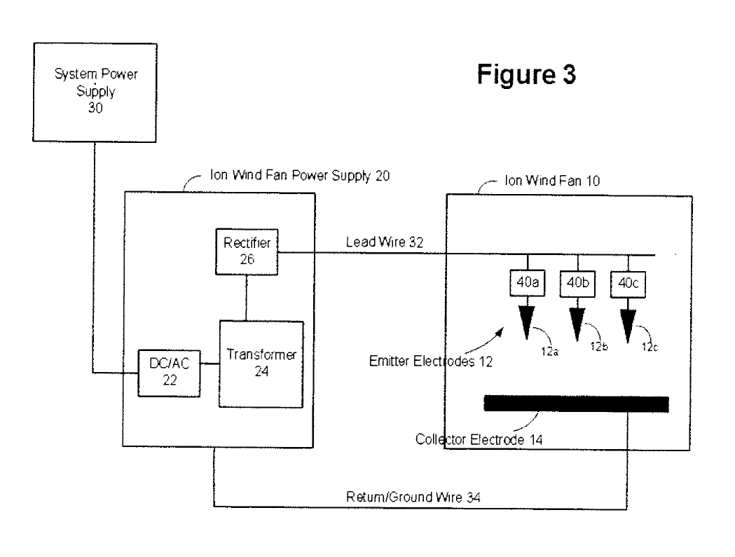

Another embodiment of locating spark mitigation resistors on the ion wind fan 10 is now described with reference to FIG. 3. Once again, since most components and elements have already been described above, they will not be described in detail with reference to FIG. 3.

In the embodiment shown in FIG. 3, instead of one resistor 40 disposed between the IWFPS 20 and emitter electrodes 12 of the ion wind fan 10 (as shown in FIGS. 2A-C), a separate spark prevention resistor 40 is used for each emitter electrode 12. For example, as shown in FIG. 3, resistor 40a is electrically coupled to emitter 12a, resistor 40b is electrically coupled to emitter 12b, and resistor 40c is electrically coupled to emitter 12c. The power flowing to each emitter electrode 12 only flows through the resistor 40 associated with the specific emitter electrode 12.

There are several advantages to the design illustrated by FIG. 3. During a spark event, the capacitive energy stored in the other non-sparking electrodes would not be discharged in the spark, but rather be dissipated in each resistor associated with the specific non-sparking emitter electrode. Also, the side effects of the spark, such as EMI and electrode damage can be further reduced using emitter-specific resistors as shown in FIG. 3.

Furthermore, during normal operation of the ion wind fan 10, the emitter-specific resistors 40a-c function to balance the load more evenly among the emitter electrodes 12. Since the resistance of an ion wind fan 10 decreases as current across the ion wind fan 10 increases, the current levels of the multiple emitter electrodes 12 may become unbalanced, with one or more emitters operating at higher current levels than other emitter electrodes. Distributing resistors in parallel on each emitter electrode 12 reduces such possible imbalance, as the voltage drop across the resistors tends to limit the current in each emitter electrode.

There are, however, also disadvantages to the configuration illustrated by FIG. 3. Multiple resistors (as many as there are emitter electrodes 12) would cost more than a single resistor and would occupy more space. Furthermore, the resistance value may be higher for each resistor when multiple resistors are used to achieve the same or similar effect as a single-resistor such as shown in FIGS. 2A-C.

In the description above, using a single resistor 40 in series with ion wind fan 10 (shown in FIGS. 2A-C) has been described in the alternative to using parallel emitter-specific resistors 40a-c (shown in FIG. 3). However, in one embodiment of the present invention, both types of resistors can be implemented simultaneously in one system. The resistances in such an embodiment would be adjusted to account for current passing through at least two resistors before reaching each emitter electrode 12; one resistor in series with the ion wind fan 10 and one resistor associated with the specific emitter electrode 12.

Throughout the preceding descriptions, it has been assumed for simplicity that the ion wind fan 10 operates using positive DC power, meaning that the emitter electrodes 12 are connected to a positive terminal of a DC power supply and the collector electrode 14 is grounded by the power supply. However, the ion wind fan 10 can function using negative DC power where the collector electrode 14 is connected to the positive terminal of the DC power supply and the emitter electrodes 12 are grounded by the power supply. In yet other embodiments, the emitter electrodes 12 may be connected to some positive voltage and the collector electrodes to some negative voltage, or vice versa. As long as the voltage potential across the emitter electrodes 12 and the collector electrode 14 exceeds the ion-generation onset voltage (sometimes referred to as the “corona onset” voltage) and is below the dielectric breakdown voltage (sparking voltage), the ion wind fan 10 can function.

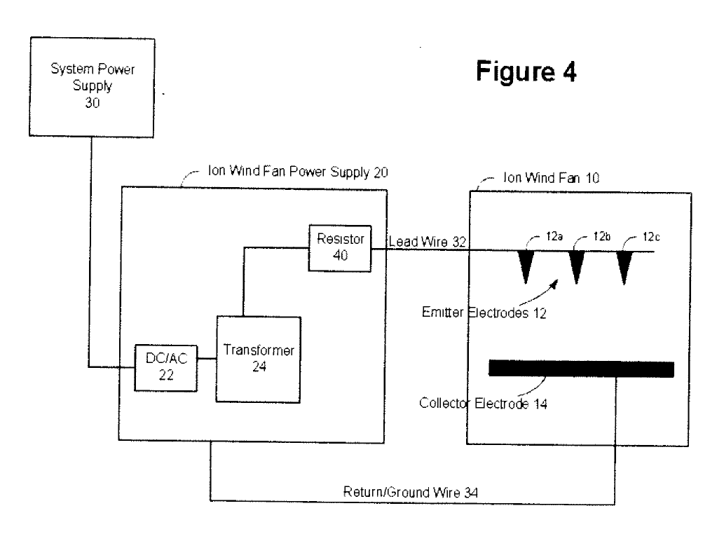

Furthermore, the ion wind fan 10 can also use AC power to function. Such an embodiment is described with reference to FIG. 4. FIG. 4 is similar to FIG. 2A, except the rectifier 26 is omitted, as the AC current coming from the transformer 24 is not converted into DC.

In an AC ion wind embodiment, such as in FIG. 4, during a spark event, most of the energy discharged during the spark is not originating in the capacitor of the rectifier 26, as in the case when DC power is used. However, the inductance energy stored in the transformer's 24 coils during a spark results in a similar increase in current. Therefore, the resistor 40 in FIG. 4 can be similar to the resistor 40 in FIG. 2A, and function in substantially the same manner during a spark event. Furthermore, the various configurations shown in FIGS. 2B, 2C and FIG. 3 can also be applied using negative DC or AC current as the power to drive the ion wind fan 10.

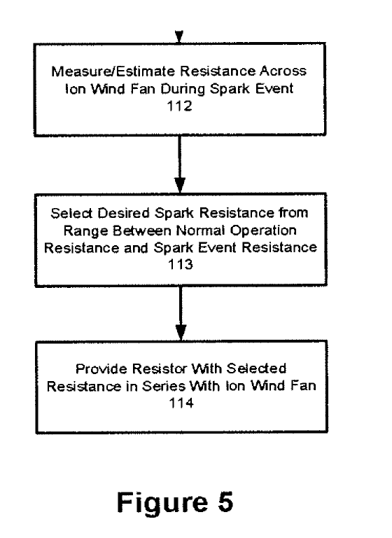

One embodiment of a method for creating a power supply, ion wind fan, or both using an embodiment of the present invention is now described with reference to FIG. 5. FIG. 5 is a flow diagram describing determining a desired resistance for a spark mitigation resistor and implementing such as resistor in an ion wind thermal management solution.

In block 111, the resistance across an ion wind fan during normal operation is measured or estimated. This can be done by turning the ion wind fan on so there is an ionic current across the air gap, and measuring the drop in current and voltage from the emitter side to the collector side. From the measured current and voltage drop, the resistance of the ion wind fan can be estimated using Ohm's law.

Another way to measure the resistance of the ion wind fan is to connect the ion wind fan to a network analyzer. The network analyzer can then measure the impedance of the ion wind fan as it would for any other electronic component. The measured impedance can even provide a more accurate resistance value of the ion wind fan, as it would account for the inductance and the capacitance of the ion wind fan as well.

In block 112, the resistance across the ion fan during a spark event is measured or estimated. This can be done by measuring current and voltage drops across the ion wind fan, as in block 111. However, the spark event is very short in duration, so it can be more convenient to estimate the resistance across the ion wind fan during a spark event by modeling using a capacitor in place of the ion wind fan. In one embodiment, block 112 can be omitted by assuming a de minimis resistance value for the ion wind fan during the spark event. Such a de minimis resistance can be assumed to be in the range of 0-50Ω.

In block 113 a desired spark resistance value is selected for the spark mitigation resistor. This value can be selected to be anywhere between the normal operation resistance measured or estimated in block 111 and the spark event resistance measured or estimated in block 112. As explained about, in some embodiments it is desirable that the spark resistance value be at least 2 orders of magnitude greater than the spark event resistance measured or estimated in block 112. Similarly, in some embodiments it is desirable that the spark resistance value be at least 2 orders of magnitude less than the normal operation resistance measured or estimated in block 111.

In block 114, a resistor with the resistance selected in block 113 is provided in series with the ion wind fan. As shown above, the resistor provided in block 114 can be physically located in the IWFPS, the ion wind fan, or anywhere electrically “between” the IWFPS and the ion wind fan. In another embodiment, such as the one illustrated in FIG. 3, multiple resistors are provided in parallel, with one resistor being provided in series and associated with each emitter electrode of the ion wind fan.

### Resistor Bypass Circuit

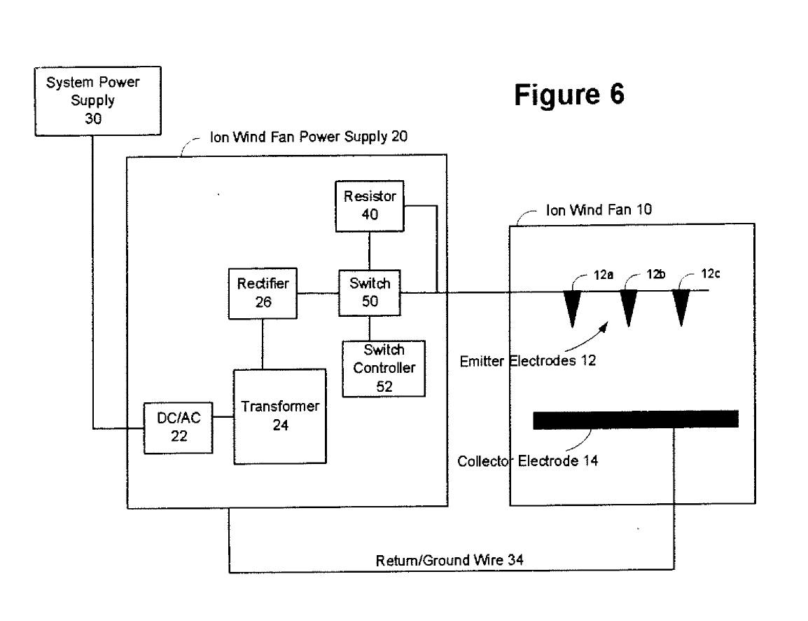

One disadvantage of providing a spark mitigation resistor in series with an ion wind fan or in series with the emitter of the ion wind fan, as described with reference to FIGS. 2-4 above, is that during normal operation of the ion wind fan, the resistor wastes energy by resisting the current and dropping the voltage between the power terminal of the IWFPS and the ion wind fan. Several embodiments of only activating the spark mitigation resistor during a spark event are now described with reference to FIG. 6. Most of the components and elements shown in FIG. 6 are substantially or exactly the same as those described with reference to FIG. 2, and therefore will not be described again.

As shown in FIG. 6, according to one embodiment of the present invention, the resistor 40 can be provided as part of a resistor bypass circuit. In other words, the resistor 40 is provided in parallel with the lead wire 32. With reference to FIG. 6, during normal operation of the ion wind fan 10, the switch 50 in the IWFPS 20 is closed, allowing current to flow substantially without resistance. A switch controller 52 is provided that can open the switch 50 during a spark event, thus forcing the current to pass through the resistor 40 via the resistor bypass circuit en route to the ion wind fan 10. Therefore, during normal operation, the IWFPS 20 functions as if the resistor 40 were not there, but during a spark event, the IWFPS 20 functions substantially as described with reference to FIG. 2A.

The switch can be a high-voltage switch implemented for example as a power MOSFET, an insulated gate bi-polar transistor (IGBT), a gaseous state switching device, or other similar high-voltage switching apparatus. In one embodiment, the switch controller 52 taps the output of the rectifier 26 (or the transformer 24 if no rectifier 26 is used) and opens the switch 50 in response to detecting voltage below a predetermined threshold. In another embodiment, the switch controller 52 triggers a switch opening upon detecting a sudden voltage drop; being sensitive not only to the absolute voltage level but the rate of change of the voltage drop.

In another embodiment, the switch controller 52 opens the switch 50 in response to detecting current above a predetermined threshold. In yet another embodiment, the switch controller 52 triggers a switch opening upon detecting a sudden current spike; being sensitive not only to the absolute current level but the rate of change of the rise of the current.

In yet another embodiment, the switch controller 52 can be optically coupled to the ion wind fan 10 such that some of the light generated by the spark event would traverse an optical connection. Upon detecting the light (visible or ultraviolet), the switch controller 52 would open the switch 52. In these embodiments discussed above, the switch 50 can remain open for a predetermined length of time based on the duration of spark events, for example for about 10 to 100 microseconds. In other embodiments, the switch can remain open until the frequency of spark events falls below a certain threshold.

In one embodiment, the switch controller 52 and the switch 50 may not be fast enough to react to a spark event because of cost limitations. However, in such a system, the resistor bypass circuit can still be beneficially used to only activate the resistor 40 during high-spark time periods. For example, in some ion wind fan implementations and systems, sparks tend to happen in clusters, such as during a change in the environment.

In such a system, the switch controller 52 can be configured to open the switch upon detecting a spark event. The switch controller 52 would then monitor future spark events, and would keep the switch 50 open—thereby passing current through the spark mitigation resistor 40—until the frequency of the sparks is below a certain threshold. Such as threshold can be no more than two sparks per hour, or no sparks for at least the last hour.

In the descriptions of the various embodiment of the present invention, the term “across” is sometimes used, as in “a voltage across the ion wind fan,” current across the ion wind fan,” a “spark across the ion wind fan,” or “across the emitter electrode and the collector electrode.” As used above, “across” the ion wind fan means across one or more emitter electrode and the collector electrode. For example, the voltage across the ion wind fan is the differential voltage between an emitter electrode (or multiple emitter electrodes) and the collector electrode.

Similarly, the terms “in series” and “in parallel” are used above in their conventional sense in the electronics arts. “In series” means that the components are electrically coupled along one path, while “in parallel” means that the same voltage is applied to each component. Thus, in FIG. 3, for example, resistor 40b is in series with emitter 12b and in parallel with resistor 40c.

What is claimed:

1. An ion wind cooling system comprising:
a transformer to step up a voltage received from a system power supply to a desired voltage;
a rectifier coupled to the transformer to convert the desired voltage into direct current having the desired voltage;
a plurality of emitter electrodes electrically coupled in parallel to the rectifier;
a collector electrode positioned so as to create an air gap between the plurality of emitter electrodes and the collector electrode;
a ground electrically coupled to the collector electrode; and
a spark mitigation resistor in series between the rectifier and the plurality of emitter electrodes, wherein the spark mitigation resistor mitigates one or more undesirable effects of a spark across one of the plurality of emitter electrodes and the collector electrode.

2. The ion wind cooling system of claim 1, wherein the one or more undesirable effects of the spark comprise one or more of a noise, an energy, damage to one of the plurality of emitter electrodes, damage to the collector electrode, and electromagnetic interference.

3. The ion wind cooling system of claim 1, wherein during normal operation of the ion wind cooling system, applying the direct current having the desired voltage to the plurality of emitter electrodes results in the generation of ions in the vicinity of the plurality of emitter electrodes, which in turn results in ion wind towards the collector electrode, and further results in a current across the plurality of emitter electrodes and the collector electrode.

4. The ion wind cooling system of claim 3, wherein the spark mitigation resistor has a resistance at least one order of magnitude less than the sum of the resistance of the plurality of emitter electrodes and the resistance of the air gap to the current.

5. A thermal management solution comprising:
an ion wind fan;
an ion wind fan power supply electrically coupled to the ion wind fan to provide a high voltage potential across the ion wind fan; and
a resistor electrically coupled to the ion wind fan power supply and the ion wind fan.

6. The thermal management solution of claim 5, wherein the resistor is to dissipate energy during a spark across the ion wind fan.

7. The thermal management solution of claim 6, wherein the resistor has a resistance that is at least two orders of magnitude greater than the resistance across the ion wind fan when a spark is present.

8. The thermal management solution of claim 7, wherein the resistor has a resistance that is at least two orders of magnitude less than the resistance across the ion wind fan when no spark is present.

9. The thermal management solution of claim 5, wherein the resistor is electrically in series with the ion wind fan.

10. The thermal management solution of claim 5, wherein the resistor is physically located in the ion wind fan power supply.

11. The thermal management solution of claim 5, wherein the resistor is physically located in the ion wind fan.

12. The thermal management solution of claim 5, wherein the resistor is physically located between the ion wind fan power supply and the ion wind fan.

13. An power supply for an ion wind fan, the power supply comprising:
a transformer to transform a voltage provided by a system power supply to a desired high voltage to operate an ion wind fan; and
a resistor electrically coupled to the transformer to mitigate a spark event of the ion wind fan, the resistor having a resistance below a resistance across the ion wind fan during normal operation but above the resistance across the ion wind fan during the spark event.

14. The power supply of claim 13, wherein the resistor mitigates the spark event by dissipating at least a portion of the energy of a sudden current increase across the ion wind fan due to the spark event.

15. The power supply of claim 13, further comprising a rectifier electrically coupled to the transformer to convert AC voltage from the transformer to DC voltage, and to provide the DC voltage to the resistor.

16. The power supply of claim 13, wherein the spark event comprises an electrical ark across an emitter electrode of the ion wind fan and a collector electrode of the ion wind fan.

17. The power supply of claim 13, wherein the resistor has a resistance at least one order of magnitude below a resistance across the ion wind fan during normal operation and also at least two orders of magnitude above the resistance across the ion wind fan during the spark event.

18. The power supply of claim 13, wherein the resistor in part of a resistor bypass circuit that is bypassed during normal operation of the ion wind fan, and the power supply further comprises a switch operable to activate the resistor bypass circuit in response to the detection of a spark event.

19. An ion wind fan comprising:
at least one emitter electrode;
at least one collector electrode separated from the emitter electrode by an air gap, wherein ion wind is generated when a high voltage potential is applied across the emitter electrode and the collector electrode; and
a resistor to mitigate the effects of a spark across the emitter electrode and the collector electrode.

20. The ion wind fan of claim 19, wherein the resistor is electrically coupled in series between a power supply providing the high voltage potential and the at least one emitter electrode.

21. The ion wind fan of claim 19, wherein the at least one emitter electrode comprises one of a wire, a shim, a blade, a trace, and a pin.

22. The ion wind fan of claim 19, wherein the collector electrode comprises a plurality of rods.

23. The ion wind fan of claim 19, wherein the resistor has a resistance at least one order of magnitude below a resistance across the emitter electrode and the collector electrode during normal operation of the ion wind fan.

24. The ion wind fan of claim 23, wherein the resistor has a resistance at least two orders of magnitude above a resistance across the emitter electrode and the collector electrode during the spark across the emitter electrode and the collector electrode.

25. An ion wind fan comprising:
a first emitter electrode electrically coupled to a first terminal of a high voltage power supply;
a second emitter electrode electrically coupled to the first terminal of the high voltage power supply;
a first resistor associated with the first emitter electrode;
a second resistor associated with the second emitter electrode; and
at least one collector electrode separated from the emitter electrode by an air gap, the collector electrode being electrically coupled to a second terminal of the high voltage power supply.

26. The ion wind fan of claim 25, wherein the first resistor is electrically coupled in series between the first terminal of the high voltage power supply and the first emitter electrode, and the second resistor is electrically coupled in series between the first terminal of the high voltage power supply and the second emitter electrode.

27. The ion wind fan of claim 25, wherein the first terminal comprises a positive terminal of the high voltage power supply.

28. The ion wind fan of claim 25, further comprising a third emitter electrode and a third resistor, the third resistor being electrically coupled in series between the first terminal of the high voltage power supply and the third emitter electrode.

29. The ion wind fan of claim 26, wherein the first resistor has a resistance in a range between a resistance across the first emitter electrode and the collector electrode during normal operation of the ion wind fan and a resistance across the first emitter electrode and the collector electrode during a spark event across the first emitter electrode and the collector electrode.

30. A method for mitigating sparks in an ion wind fan, the method comprising:
estimating a resistance across the ion wind fan; and
selecting a resistance for a spark mitigation resistor, the selected resistance being at least one order of magnitude less than the estimated resistance across the ion wind fan.

31. The method of claim 30, further comprising installing a resistor having the selected resistance into a power supply for the ion wind fan.

32. The method of claim 30, further comprising installing a resistor having the selected resistance into the ion wind fan.

33. The method of claim 30, further comprising installing a resistor having the selected resistance into an electronics device containing the ion wind fan.
